(19) United States
(12) Patent Application Publication
(10) Pub. No.: US 2024/0075638 A1
(43) Pub. Date: Mar. 7, 2024

(54) MAGNETIC JOINT ASSEMBLIES FOR ACTIVE-PASSIVE ROBOTIC EXOSKELETON SYSTEMS AND METHODS FOR MAKING THE SAME

(71) Applicant: Motion Augmented LLC, Farmington Hills, MI (US)

(72) Inventors: Cameron Brandon Pinnock, Farmington, MI (US); Haroun Algahmi, Detroit, MI (US)

(73) Assignee: Motion Augmented LLC, Farmington Hills, MI (US)

(21) Appl. No.: 18/458,314

(22) Filed: Aug. 30, 2023

Related U.S. Application Data
(60) Provisional application No. 63/418,135, filed on Oct. 21, 2022.
(60) Provisional application No. 63/403,425, filed on Sep. 2, 2022.

(51) Int. Cl. B25J 17/00; B25J 9/00; B25J 19/00

(52) U.S. Cl. CPC B25J 17/00; B25J 9/0006; B25J 19/007

(57) ABSTRACT

A modular passive-to-active exoskeleton system utilizes motor unit modules, an electromagnetic-clutch power transmission system, and biometric control. A passive exoskeleton may have a stamina-increasing “chairless chair” function and optional use of magnetic ball-and-socket joints and knee gas-and-torsion springs. To convert the exoskeleton system into an active wearable robotic device, modular attachments allow for motor units to be securely connected to and disconnected from the exoskeletal frame. An exoskeleton system may employ modular motor units that have a transmission system with an electromagnetic clutch that enables a passive mode, active mode, and/or hybrid mode. The motor units may be controlled using wireless biometric sensors that measure limb joint angle and muscle activity. These motor units also communicate via wireless transmission with a central processing unit of the exoskeleton. This central processing unit serves as a gateway for user feedback from an Internet-of-Things (IoT) device, such as a smartphone, tablet, computer, etc.

### CLAIM OF PRIORITY AND CROSS-REFERENCE TO RELATED APPLICATIONS

This application claims the benefit of and priority to U.S. Provisional Patent Application No. 63/403,425, which was filed on Sep. 2, 2022, and U.S. Provisional Patent Application No. 63/418,135, which was filed on Oct. 21, 2022, both of which are incorporated herein by reference in their respective entireties and for all purposes.

### TECHNICAL FIELD

The present disclosure relates generally to wearable devices and systems for assisting with motion of a user. More specifically, aspects of this disclosure relate to wearable exoskeleton systems for assisting human motion and reducing energy expenditure attendant thereto.

### BACKGROUND

Many exoskeletons on the market are used in medical rehabilitation and industrial applications that require heavy lifting or other atypical dynamic movements. The exoskeletons in both of these applications typically do not incorporate features that allow the wearers to use their own natural strength while healing or to quickly escape from danger while on the job. Even though a reason for using exoskeletons in this manner is to assist the wearer, the user may eventually wish to rely on their own strength without supplemental assistance, e.g., via an exoskeletal electric motor. Many applications may be directed to rehabilitation of minor injuries and for uninjured individuals that are using the exoskeleton system to conserve energy while doing tasks. In such applications, having the ability to walk or lift with assistance via a motor and, when desired, run or move freely without motor-assistance may be crucial in the engineering of an exoskeleton suit.

Exoskeletons may be controlled using a variety of different methods. For instance, an exoskeleton may be controlled autonomously via computer programmed software (e.g., in instances where the user is paralyzed from the waist down). Another method includes using walking sticks that have force sensors or motion sensors that work in cadence with the exoskeleton robot. Electromyograph (EMG) and electroencephalograph (EEG) sensors may also be employed to control an exoskeleton system (e.g., for users that are partially or completely paralyzed from the waist down). Additionally, motion sensors may be employed to measure joint angles to aid in providing direction for the exoskeleton. Available types of biometric sensors that may be utilized in exoskeleton systems include, for example, motion joint angle sensors worn on the user's body, force sensors worn on the user's hands and feet, EMG sensors, and EEG sensors. However, many commercially available biometric sensors are costly, cumbersome, and/or contain numerous wires that complicate system assembly and can be inconvenient for the end user.

Exoskeleton technology has been in use experimentally since the mid-20th century and has since gained much traction. An example of a “Reconfigurable Exoskeleton” is presented in U.S. Patent App. Pub. No. 2015/0351995 A1, to Adam Zoss et al., which utilizes a modular joint system to enable reconfigurable exoskeleton limbs. The Zoss exoskeleton is a powered exoskeleton system that allows for limb actuation at the joints for assistance during walking. Even though this device is less bulky than many other available exoskeletons, it moves slowly and is only meant for rehabilitation purposes for individuals with lower extremity paralysis. Users are not able to run with the Zoss exoskeleton nor are they able to move with the system power off.

An example of a “Motorized Exoskeleton Unit” is shown in U.S. Patent App. Pub. No. 2013/0253385 A1, to Amit Goffer et al., which is designed for a lower body extremity. In this example, the exoskeleton's joints are motorized to allow for actuation of the limbs. Goffer's device is designed to assist someone while walking and for related bipedal locomotion. In addition, this device contains a motor that is only connected to a lower limb and does not contain a clutching mechanism to allow the individual the freedom to move on their own.

An example of a robotic “Wearing-Type Movement Assistance Device” is shown in U.S. Patent App. Pub. No. 2017/0144309 A1, to Yoshiyuki Sankai, which uses drive units to provision lift assistance using angle joint sensors to control the exoskeleton. Sankai's exoskeleton includes an upper limb assistance section joined to a lower limb assistance section with motorized hip, shoulder, and elbow joints to aid someone while performing tasks. However, the exoskeleton drive motors in this design are permanent fixtures and, thus, are not readily attachable and removable by the end user. In general, Sankai uses hardwired (non-wireless) sensors and a fixed (non-modular) exoskeleton system architecture.

None of the above-described examples of wearable exoskeletons are hybrid passive-and-active robotic exoskeletons in which the end user can readily add and remove motor units or selectively engage and disengage the motor units when desired. Additionally, none of the above motorized exoskeleton examples utilize a clutch device for the selective transmission of power from the motor to actuate a limb to enhance the user's strength, nor are they being controlled via wireless sensor technology. All of the above discussed U.S. Patents and Patent Application Publications are incorporated herein by reference in their respective entireties and for all purposes.

### SUMMARY

Presented herein are exoskeleton systems with attendant control logic for assisting users with movement, power clutch transmissions for exoskeletons, articulating joint and appendage units for exoskeletons, modular motor units for exoskeletons, wireless biometric controls systems for exoskeletons, and methods for making and methods for operating disclosed exoskeletons, transmissions, motor units, appendage-joint assemblies, and/or biometric systems. In an example, there is presented a modular exoskeleton adaptable with modular motor unit attachments that increase a user's strength when electrically powered. When not powered, the exoskeleton is in a passive operating mode that allows the user to freely move without assistance. The user can detach the motor units and customize the passive exoskeleton to multiple different architectures. Disclosed exoskeleton systems may employ Internet of Things (IoT) technology, e.g., that uses BLUETOOTH® Low Energy technology (BLE), to connect biometric sensors to a central processing unit (CPU) of the exoskeleton and, if desired, to other resident system devices.

Aspects of this disclosure are also directed to hybrid power clutch transmission devices, e.g., for an elbow/knee motor unit, a hip/shoulder motor unit, and/or other motorized limb units of an exoskeleton system. The hybrid transmission and attendant control scheme is enabled via one or more electromagnetic clutches that engage and take up torque capacity when powered to thereby initiate a strength-enhancing active operating mode of the exoskeleton system. When not powered, the electromagnetic clutch or clutches disengage and slip to enable a passive operating mode of the exoskeleton system. An optional hybrid operating mode may default to a passive-type operating mode and automatically trigger an active-type operating mode when wireless biometric sensors activate clutch engagement when increased muscle activity is predicted or sensed.

The weight-bearing structure of the exoskeleton system may include an exoskeleton frame, which may contain an upper body mechanical structure and/or a lower body mechanical structure. The exoskeleton frame may use high-strength magnetic ball-and-socket joints for the hip and shoulder joint regions, e.g., to increase range of motion via mimicking the same regions of the human body. Knee and elbow joint regions of the exoskeleton frame structure may be spring loaded, e.g., via a torsion and/or gas spring joint. A leg region of the exoskeleton frame structure may contain a magnetic sliding lock mechanism that can be used to lock a gas spring when disengaged; when engaged, the sliding lock mechanism may unlock the gas spring such that the user can bend their knee. The sliding lock mechanism may allow the wearer to hold a desired position without the associated motor(s) being powered.

The exoskeleton frame structure may be made active, at least in part, via the attachment of one or more computer-controlled motor units. When powered on, these motor units supplement user strength for the wearer of the exoskeleton system. Output of these motor units may be governed by a system central processing unit (CPU) based on feedback from a distributed network of wireless biometric sensors. Biometric sensors that are used to control the exoskeleton system may include motion sensors for detecting angle positioning and EMG sensors for detecting muscle activity. A modular exoskeleton architecture may be designed to add one or more motor units in order to enable an active robotic exoskeleton that provides multiple uses for the wearer as well as various economic benefits. When set in a passive operating mode, the exoskeleton frame structure may provide the user with the ability to stand or hold a squatting position, e.g., via mechanically locking parts of the exoskeleton. When set in an active operating mode, a user can add one or more motor units to aid in augmenting the wearer's strength capabilities. This enables a user to purchase/integrate only what is needed, and to modify the exoskeletal functionality at any time, rather than being limited to buying/using either a passive exoskeleton or a robotic exoskeleton.

Disclosed motorized exoskeleton systems may contain one or more articulating joint assemblies, such as a knee module, each of which may be equipped with an electromagnetic clutch, e.g., for safety, increased freedom of movement, and decreased battery power consumption. Safety is a top priority for many applications when designing exoskeletons. For instance, a user may be protected from injury if a CPU error occurs because the system is able to decouple the motor from the limb. Also, the motor and transmission gears will be protected from damage if an error occurs. Increased freedom of movement may enable improved safety since disengaging the electromagnetic clutch or clutches enables the user to move without hinderance at their own speed and under their own control, e.g., to escape danger or to work faster. Unlike many commercially available motorized exoskeletons, in which the user can only move as fast as the exoskeleton motor allows them to move, disclosed exoskeleton systems help to enable both active and passive operation for unencumbered movement. Moreover, the ability to drivingly decouple the motor units reduces motor use with a concomitant reduction in energy consumption and wear; in so doing, the user can activate the exoskeleton system's assisted walking and lifting features when desired.

Attendant advantages for at least some of the disclosed concepts may include modular motor unit designs that are structurally configured to be easily attached to an exoskeleton suit, e.g., providing an active exoskeleton architecture that enables assisted movement with enhanced strength via robotic actuation. At the same time, disclosed modular motor units are structurally configured to be easily detached from an exoskeleton suit, e.g., providing a passive exoskeleton architecture that enables the user to rely on their own strength and stamina with the enhanced stability provided by the suit. To simplify motor attachment/detachment while reducing system cost, weight, and complexity, disclosed motor units may communicate wirelessly with on-board controllers and sensors. The modularity and interchangeability of the motor unit modules further reduces system complexity and manufacturing costs while optimizing cross-platform adaptability and improving end-user experience.

Aspects of this disclosure are directed to articulating joint assemblies and articulating joint-and-appendage assemblies for exoskeleton systems, including full-body and partial-body exoskeleton (“exo”) frame configurations. In an example, a joint assembly is presented for an exoskeleton system having an exoskeleton frame with multiple frame segments. The joint assembly includes, for example, a socket outer shell that has an internal socket hole and attaches to a first segment of the exoskeleton frame, and a ball outer shell that has an internal shaft hole and attaches to a second segment of the exoskeleton frame. The joint assembly also includes a ball-and-socket assembly with a magnetic socket having a socket cavity, a magnetic ball movably nested in the socket cavity and magnetically mated with the magnetic socket, and a ball shaft rigidly attached to and projecting from the magnetic ball. The magnetic socket is located inside the internal socket hole and rigidly attached to the socket outer shell, and the ball shaft is located inside the internal shaft hole and rigidly attached to the ball outer shell.

Additional aspects of this disclosure are directed to hybrid active-passive exoskeleton systems for assisting with user movement. As used herein, the terms “exoskeleton” and “exoskeleton system”, including permutations thereof, may be used interchangeably and synonymously to include any relevant exoskeleton platform, such as: medical exoskeletons, industrial exoskeletons, and combat exoskeletons; passive-type, active-type, and hybrid-type exoskeletons; fixed architectures, supported architectures, and mobile architectures; soft-suit and hard-suite designs; and full-body, lower-extremity, and upper-extremity exoskeletons, etc. In an example, an exoskeleton system includes an exoskeleton frame with a first frame segment that securely attaches to a trunk of a user (e.g., the user's waist and/or back) and a second frame segment that attaches to an appendage of the user (e.g., the user's thigh and/or upper arm).

Continuing with the preceding discussion, the exoskeleton system is also equipped with one or more articulating joint assemblies, each of which includes a rotational coupling, a socket outer shell, a connector bracket, a ball outer shell, and a ball-and-socket assembly. The rotational coupling rotatably attaches to the first frame segment of the exoskeleton frame, and the socket outer shell attaches to the rotational coupling. Comparatively, the connector bracket rigidly attaches to the second frame segment of the exoskeleton frame, and the ball outer shell attaches to the connector bracket. The ball-and-socket assembly includes a magnetic socket with a recessed socket cavity, a magnetic ball that is movably nested in the socket cavity and magnetically mated with the magnetic socket, and a ball shaft that is rigidly attached to and projects from the magnetic ball. The magnetic socket is located inside an internal socket hole of the socket outer shell and, once inserted, is rigidly attached to the socket shell. The ball shaft, on the other hand, is located inside an internal shaft hole of the ball outer shell and is rigidly attached to the ball shell.

Aspects of this disclosure are also directed to manufacturing workflow processes, computer-readable media, and control logic for making or for using any of the herein described exoskeleton systems, modular motor unit assemblies, biometric sensor arrays, joint and J&A assemblies, and/or any other disclosed hardware and componentry. In an example, a method is presented for assembling a joint assembly for an exoskeleton system. The exoskeleton system includes an exoskeleton frame with multiple interconnected frame segments. This representative method includes, in any order and in any combination with any of the above and below disclosed options and features: attaching a socket outer shell to a first frame segment of the exoskeleton frame, the socket outer shell defining therein an internal socket hole; attaching a ball outer shell to a second frame segment of the exoskeleton frame, the ball outer shell defining therein an internal shaft hole; receiving a ball-and-socket assembly including a magnetic socket defining a socket cavity, a magnetic ball movably nested in the socket cavity and magnetically mated with the magnetic socket, and a ball shaft rigidly attached to and projecting from the magnetic ball; inserting the magnetic socket into the internal socket hole; attaching the magnetic socket to the socket outer shell; inserting the ball shaft into the internal shaft hole; and attaching the ball shaft to the ball outer shell.

For any of the disclosed joint assemblies, exo systems, and methods, the joint assembly may also include a socket capsule that is located inside the internal socket hole of the socket outer shell and surrounds the magnetic socket. In this example, the socket capsule may be rigidly attached to the socket outer shell and interposed between the magnetic socket and the socket outer shell. It may be desirable that the socket capsule be fabricated, e.g., molded from a rigid polymeric material, as a hollow and cylindrical one-piece structure with open terminal ends and a flange projecting radially outward from one terminal end of the socket capsule. As another option, the magnetic socket may be cylindrical, the magnetic ball may be spherical, and the ball shaft may be cylindrical. In this instance, the magnetic socket may be fabricated, e.g., cast from a magnetic material as a discrete (first) one-piece structure, and the magnetic ball and the ball shaft may be fabricated, e.g., cast and welded from a magnetic material, as another (second) one-piece structure.

For any of the disclosed joint assemblies, exo systems, and methods, the socket outer shell may be fabricated, e.g., molded from a rigid polymeric material, as a hollow, truncated polyhedral one-piece structure. In the same vein, the ball outer shell may be fabricated, e.g., molded from a rigid polymeric material, as a hollow, polyhedral one-piece structure. As another option, the first frame segment may include a waist assembly, which attaches to a waist of a user, or a back plate assembly, which attaches to a back of the user, and the second frame segment may include a thigh assembly, which attaches to a thigh of the user, or an arm assembly, which attaches to an arm of the user. In this instance, the joint assembly may be a hip joint assembly, which movably attaches the thigh assembly to the waist assembly, or a shoulder joint assembly, which movably attaches the arm assembly to the back plate assembly.

For any of the disclosed joint assemblies, exo systems, and methods, a connector bracket plate may rigidly attach to both the ball outer shell and the second frame segment to thereby attach the ball outer shell to the second frame segment. Comparatively, a rotational coupling may rigidly attach to the socket outer shell and rotatably attach to the first frame segment to thereby attach the socket outer shell to the first frame segment. As another option, a connector bracket may extend between and rigidly attach the socket outer shell to the rotational coupling such that the ball outer shell and ball shaft are pivotable with respect to the rotational coupling. A motor adaptor mounting bracket may rigidly attach to the ball outer shell; this mounting bracket removably mounts thereon a motor unit.

The above Summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is a front, perspective-view illustration of a representative full-body modular exoskeleton system without motor unit modules in accord with aspects of this disclosure.

FIG. 2 is a partially exploded, front perspective-view illustration of a representative full-body modular exoskeleton system with motor unit modules and connectors for mounting motor unit modules to the exoskeleton frame of FIG. 1 in accord with aspects of this disclosure.

FIG. 3 is a side, perspective-view illustration of a representative articulating joint (passive hip) assembly for an exoskeleton system in accord with aspects of this disclosure.

FIG. 4 is a partially exploded, perspective-view illustration of the representative articulating joint assembly of FIG. 3.

FIG. 5 is a side, perspective-view illustration of a representative articulating joint & appendage (J&A; passive shoulder and upper arm) assembly for an exoskeleton system in accord with aspects of this disclosure.

FIG. 6 is a partially exploded, perspective-view illustration of the representative articulating joint & appendage assembly of FIG. 5.

FIG. 7 is a side, perspective-view illustration of another representative articulating joint and appendage (J&A or passive knee and thigh) assembly, shown in a locked state, for an exoskeleton system in accord with aspects of this disclosure.

FIG. 8 is a side, perspective-view illustration of the representative articulating joint & appendage assembly of FIG. 7, shown in an unlocked state.

FIG. 9 is an enlarged and partially exploded perspective-view illustration of a representative motor-clutch button assembly of the representative articulating J&A assembly of FIGS. 7 and 8.

FIG. 10 is an enlarged, perspective-view illustration of another representative articulating joint (passive knee) assembly of the representative articulating J&A assembly of FIGS. 7 and 8.

FIG. 11 is an exploded, perspective-view illustration of the representative articulating joint subassembly of FIG. 10.

The present disclosure is amenable to various modifications and alternative forms, and some representative embodiments are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as exemplifications of the disclosed principles, not limitations of the broad aspects of the disclosure. To that extent, elements and limitations that are described, for example, in the Abstract, Technical Field, Background, Summary, and Detailed Description sections, but not explicitly set forth in the claims, should not be incorporated into the claims, singly or collectively, by implication, inference, or otherwise.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein in the sense of “at, near, or nearly at,” or “within 0-5% of,” or “within acceptable manufacturing tolerances,” or any logical combination thereof, for example.

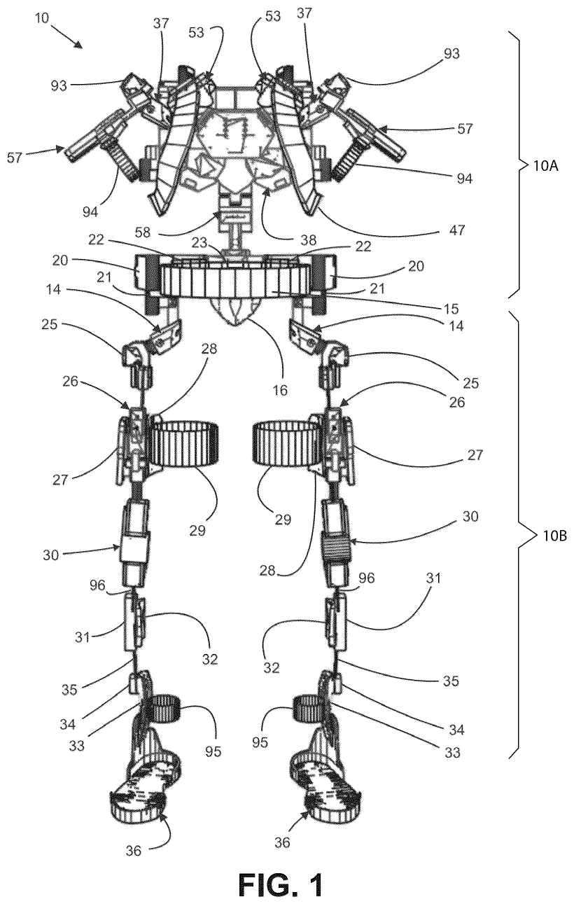

Referring now to the drawings, wherein like reference numbers refer to the same or similar features throughout the several views, there is shown in FIG. 1 a representative exoskeleton system, which is designated generally at 10 and portrayed herein for purposes of discussion as a modular, hybrid-type full-body wearable exoskeleton structure for an “average” adult human. The illustrated exoskeleton system 10—also referred to herein as “exoskeleton structure” or “exoskeleton” for short—is merely an exemplary application with which novel aspects of this disclosure may be practiced. As such, it will be understood that aspects and features of this disclosure may be implemented for any desired exoskeleton application (e.g., industrial, commercial, medicinal, combat, etc.), may be scaled and adapted for users of different sizes, shapes, and species, and may be incorporated into any logically relevant type of exoskeleton architecture (e.g., full-body, lower-extremity, upper-extremity, etc.). Moreover, only select components of the exoskeleton systems and attendant subassemblies are shown and described in additional detail below. Nevertheless, the exoskeletons and exoskeleton hardware discussed herein may include numerous additional and alternative features, and other available peripheral components, for carrying out the various methods and functions of this disclosure.

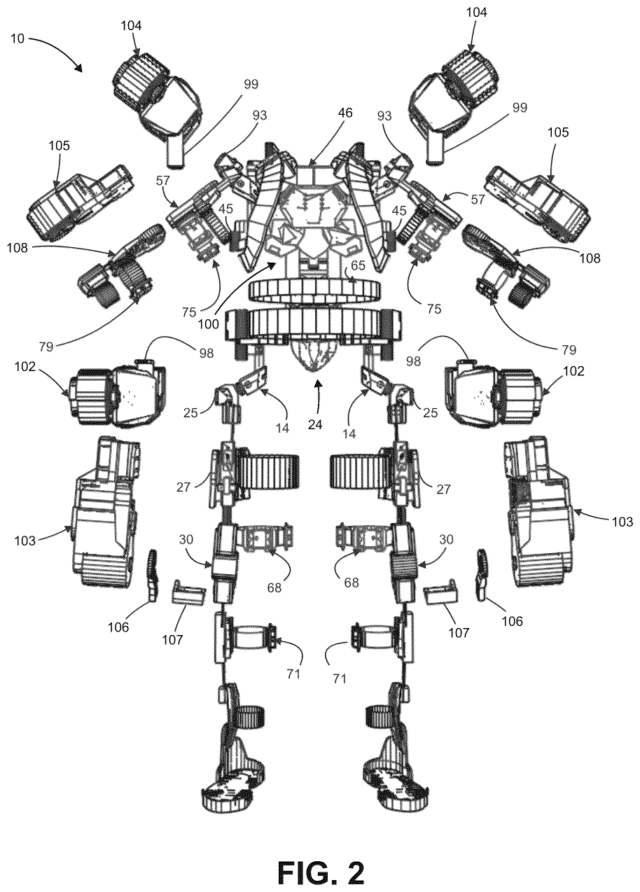

The exoskeleton system 10 of FIGS. 1 and 2 may be generally delineated into two interconnectable segments: (1) an upper extremity (first) frame section 10A, which generally extends from a waist-hip midpoint to a neck region and physically mounts to a user's trunk region; and (2) a lower extremity (second) frame section 10B, which generally extends from the waist-hip midpoint to a foot and ankle region and physically mounts to one or both legs of a biped. The upper extremity frame section 10A of the exoskeleton system 10 is releasably joined via a hip assembly 14 to the lower extremity frame section 10B. With his arrangement, the exoskeleton system 10 may be readily modified (e.g., without specialized tools or permanently damaging the skeletal structure) for use of just the upper section 10A, just the lower section 10B, or both sections 10A, 10B. The hip assembly 14, in turn, is connected to an outer waist-hip beltloop shell 21, which includes a waist belt 15 that is looped through a central waist belt loop (not visible in this view) to secure the upper section 10A to the user's waist. A waist belt loop cover 22 is placed on top of the beltloop shell 21 to secure the waist belt 15; the beltloop shell 21 is connected via a waist bracket 20 to the hip assembly 14 and a spine unit assembly 58. A waist central unit and a waist bracket unit (not visible in this view) cooperate with waist bracket units 20 to create an adjustable waist support for the exoskeleton system 10.

Lower outer side regions of the hip assembly 14 of FIGS. 1 and 2 connect to a pair of (left and right) exoskeleton hip motor adaptors 25, whereas a bottom region of each hip motor adaptor 25 connects to a respective (left or right) exoskeleton thigh assembly 26. An outer side region of each thigh assembly 26 is connected to a respective exoskeleton knee motor adaptor 27, whereas an inner side region of each thigh assembly 26 is connected to a respective femur outer shell 28. The left (first) and right (second) thigh assemblies 26 each employs a respective thigh strap 29 to releasably attach the thigh assemblies 26 and, thus, the lower extremity section 10B to a user's thighs/upper legs. Each thigh assembly 26 is connected to a respective tibial bracket connector 31 via a respective joint assembly 430 and a respective lower leg upper bracket 496. As will be described in further detail below, the two (left and right) knee assemblies 30 detachably mount thereto knee motor units for mechanization of the user's knee joints. An inner side region of each tibial bracket connector 31 is connected to a respective tibial outer shell 32 that may abut one of the user's tibias (e.g., along the fibularis and tibialis muscles). An optional gas spring (not visible in this view) may connect the thigh assembly 26 to the knee assembly 30.

Continuing with the discussion of the exoskeleton's lower extremity section 10, the two (left and right) tibial bracket connectors 31 are each connected to a respective ankle outer shell 33 via a respective lower leg bracket 35. The two (left and right) lower leg brackets 35 are attached to the (left and right) ankle outer shells 33 via respective shin size adjusters 34, e.g., that may enable the selective lengthening and shortening of the lower extremity section 10B. Inner side regions of the ankle outer shells 33 are each provided with an ankle strap 95 that wraps around and releasably attaches the ankle outer shells 33 and, thus, the lower extremity section 10B to the user's ankles/lower legs. A bottom outer side region of each ankle outer shell 33 is attached to a respective exoskeleton foot outer shell 36, which seats thereon and operatively attaches to a user's foot/shoe/boot. The two (left and right) ankle outer shells 33 may articulate (e.g., rotate to enable dorsiflexion and plantarflexion of foot shell 36) with respect to the tibial bracket connectors 31, the connectors 31 may articulate with respect to the thigh assemblies 26 (e.g., rotate about the joint assembly 430 to enable tibial extension and flexion), and the thigh assemblies 26 may articulate with respect to the waist bracket 20 (e.g., rotate about the hip assembly 14 to enable femoral extension and flexion).

To securely attach and selectively detach the lower extremity section 10B to/from the upper extremity section 10A, e.g., for a “full body” exoskeleton architecture, the hip assembly 14 releasably attaches to a bottom end of the spine unit assembly 58 via a socket assembly 23 and a tailbone outer shell 16. This spine unit assembly 58 connects at an upper end thereof to a flexible back plate assembly 38, which may abut a wearer's thoracic region. Left and right flanks of the back plate assembly 38 of FIGS. 1 and 2 are provided with respective shoulder outer shell assemblies 53 that contact and attach to the user's shoulders. A respective shoulder harness 47, for example, releasably attaches each shoulder assembly 53 and, thus, the back plate assembly 38 and upper extremity section 10A to the user's left and right shoulders/upper body. In this vein, the two (left and right) shoulder harnesses 47 and the two (left and right) shoulder outer shell assemblies 53 aid in keeping the back plate 38 attached to the user's back. An outer side region of each exoskeleton shoulder assembly 37 attaches to an exoskeleton shoulder motor adaptor 93 for attaching thereto a respective shoulder motor unit. The shoulder assemblies 37 also couple to upper arm bracket assemblies 57, each of which includes an upper arm strap 94 that wraps around and releasably attaches the shoulder assemblies 37 and, thus, the upper extremity section 10A to the user's humerus/upper arm regions.

To transform the unassisted, passive-type exoskeleton architecture of FIG. 1 to a motor-assisted, active-type exoskeleton architecture, FIG. 2 presents a perspective view illustration of the modular exoskeleton system 10 of FIG. 1 with a distributed array of motor unit modules that are detachably connected via complementary motor unit connectors to the various motor adaptor sections of the exoskeleton 10. In accord with the illustrated example, a pair of (right and left) hip motor unit modules 102 mount on and drivingly connect to the hip motor adaptors 25 on the lower extremity section 10B of exoskeleton 10. Each modular hip motor unit 102 is equipped with a respective hip rotational bracket 98 that connects the motor unit 102 to the hip assembly 14. In so doing, the hip motor unit modules 102 of FIG. 2 are selectively actuable—individually and in unison—to boost and/or automate movement of the hip assemblies 14 and, thus, the hip joints and upper legs of the user.

A pair of (right and left) knee motor unit modules 103 each mounts on a respective thigh assembly 26 via one of the knee motor adaptors 27 and drivingly connects to a respective joint assembly 430 via one of the knee motor unit brackets 106. Each mated modular knee motor unit 103 and corresponding bracket 106 securely attaching to their respective joint assembly 430 via a knee bracket alignment adaptor 107. In so doing, the motor unit modules 103 of FIG. 2 are selectively actuable—individually and in unison—to boost and/or automate movement of the knee assemblies 30 and, thus, the user's knee joints and lower legs. When operated in unison, the motor unit modules 102, 103 may assist with gaited locomotion of a user as well as jumping, squatting, climbing, lifting, etc. While shown with four motor units, it is envisioned that the lower extremity frame section 10B of the exoskeleton system 10 may employ only a single motor unit or a subset of the illustrated motor units depending, for example, on the intended application of the system.

With continuing reference to FIG. 2, a pair of (left and right) shoulder motor unit modules 104 each mounts on and drivingly connects to a respective shoulder motor adaptor 93 on the upper extremity section 10A of the exoskeleton 10. Each modular shoulder motor unit 104 is equipped with a respective shoulder rotational bracket 99 that securely connects the motor unit 104 to a respective back shoulder unit adaptor 45 on the back plate assembly 38. In so doing, the motor unit modules 104 of FIG. 2 are selectively actuable—individually and in unison—to boost and/or automate movement of the exoskeleton shoulder assemblies 37 and, thus, the shoulder joints and upper arms of the user.

A pair of (left and right) elbow motor unit modules 105 each mounts on a respective one of the shoulder assemblies 37 and drivingly connects to a complementary forearm attachment assembly 108. Each forearm attachment assembly 108 may removably attach to a user's forearm via straps (as shown). In this regard, each of the herein-described joint and appendage assemblies may employ straps, cables, harnesses, cuffs, or any other suitable means of attachment to operatively mount onto a user. Each of the modular elbow motor units 105 securely attaches to a respective upper arm bracket assembly 57 on one of the exoskeleton shoulder assemblies 37. In so doing, the motor unit modules 105 of FIG. 2 are selectively actuable—individually and in unison—to boost and/or automate movement of the exoskeleton elbow assemblies and, thus, the user's elbow joints and forearms. When operated in unison, the motor unit modules 104, 105 may assist with movement of the upper appendages, e.g., to facilitate lifting, throwing, carrying, gait-related arm swing, etc. While shown with four motor units, it is envisioned that the upper extremity frame section 10A of the exoskeleton system 10 may employ only a single motor unit or a subset of the illustrated motor units depending, for example, on the intended application of the system.

To govern individual and synchronized operation of the motor unit modules 102, 103, 104, 105, the exoskeleton system 10 may employ a distributed array of sensing devices for actively monitoring real-time or near real-time user variables and system characteristics. The sensing devices may include: (1) a waist biometric sensor assembly 65; (2) a pair of thigh biometric sensor assemblies 68; (3) a pair of lower leg biometric sensor assemblies 71; (4) a pair of upper arm biometric sensor assemblies 75; and (5) a pair of forearm biometric sensor assemblies 79. A rechargeable battery pack 100 is attached to the back of the back plate assembly 38 and operable to power the exoskeleton's various electronic components. A lower body subsystem CPU 24 provisions input/output (I/O) logic-controlled operation of the sensors, motors, etc., of the lower extremity section 10B, whereas an upper body subsystem CPU 46 provisions I/O logic-controlled operation of the sensors, motors, etc., of the upper extremity section 10A. As noted above, detachment of the upper and lower extremity sections 10A, 10B of the active-passive exoskeleton 10 from each other creates a stand-alone lower body active/passive exoskeleton unit and a stand-alone upper body active/passive exoskeleton unit that may be operated independently from each other. This allows the user to further customize use of the exoskeleton 10 to a myriad of distinct upper and lower body applications. Additional information about the contents, arrangement, and functionality of the exoskeleton system 10 may be found in commonly owned U.S. Provisional Patent App. Nos. 63/403,425 (hereinafter “'425 Application”) and 63/418,135 (hereinafter “'135 Application”), and U.S. Non-Provisional patent application Ser. No. 18/160,356 (hereinafter “'356 Application”), Ser. No. 18/181,637 (hereinafter “'637 Application”), Ser. No. 18/298,687 (hereinafter “'687 Application”), and Ser. No. 18/347,132 (hereinafter “'132 Application”), all of which are incorporated herein by reference in their respective entireties and for all purposes.

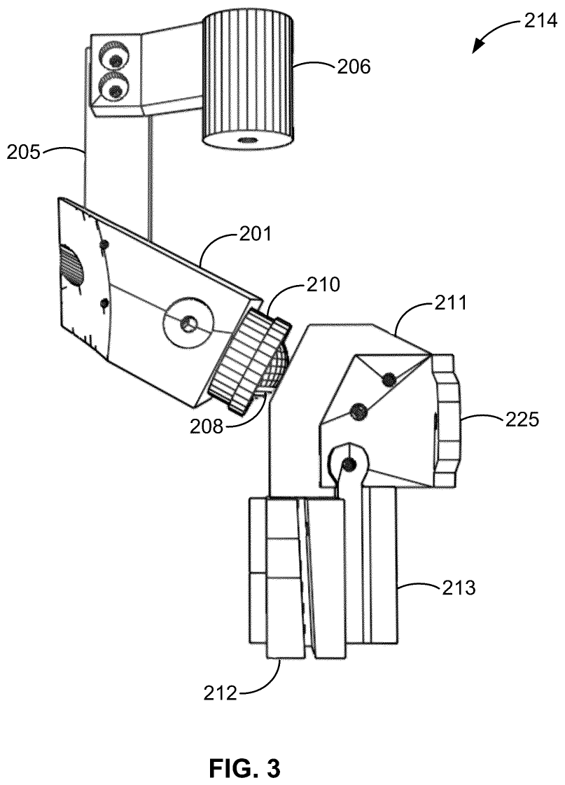

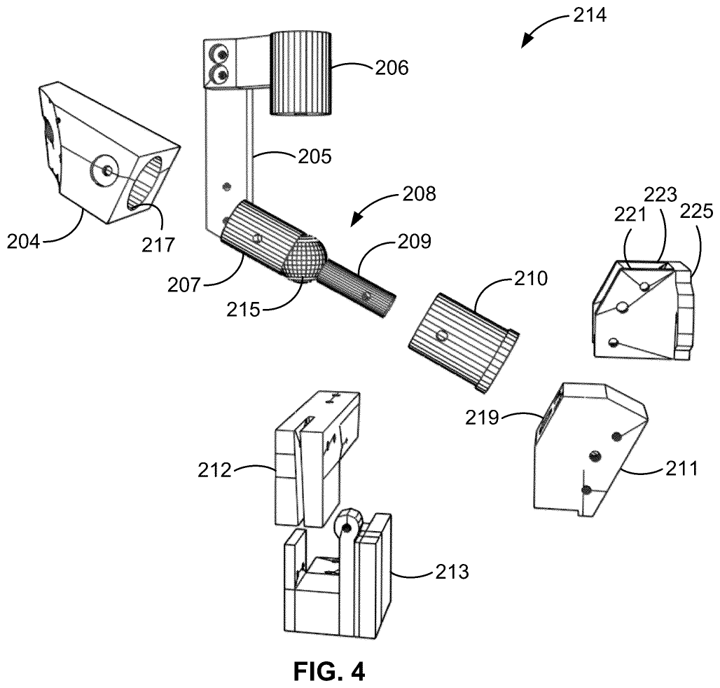

Turning next to FIG. 3, there is shown an example of an articulating joint assembly 214 that may be adapted for use as the hip assembly 14 and hip motor adaptor 25 of FIGS. 1 and 2 (e.g., wherein a left joint assembly may be a mirror image of a right joint assembly). In accord with the illustrated example, the articulating joint assembly 214 of FIGS. 3 and 4 (also referred to herein as “passive hip exoskeleton unit”) may include at least the following components: a rigid socket outer shell 204, a rigid connector bracket 205, a swivel-type rotational coupling 206, a ball-and-socket (B&S) magnetic hip socket 207, a B&S ball shaft assembly 208 with a magnetic ball shaft 209 welded to a magnetic ball 215, a rigid B&S socket capsule 210, a B&S hip ball outer shell 211, an L-shaped connector bracket plate 212, a ligament alignment plate 213, and a flanged motor adaptor 225 mounting bracket. Each of these components (excepting the magnetic parts) may be fabricated from a rigid and lightweight material, such as aluminum or titanium, including alloys thereof, as well as polymeric materials, such polypropylene (PP), polyvinyl chloride (PVC), and fiber-reinforced polymers (FRP). The magnetic hip socket 207, magnetic ball 215 and, if desired, the magnetic ball shaft 209 may each be fabricated from permanent magnet materials, such as rare earth magnets. While described herein for use as a hip joint, it should be appreciated that the articulating joint assembly 214 may be employed for other exoskeleton joint locations without departing from the intended scope of this disclosure. It should also be recognized that the illustrated joint assemblies may include greater or fewer components than what is illustrated, and some of the illustrated components may be modified, combined, or eliminated.

The cylindrical and hollow rotational coupling 206 may be rigidly mounted, e.g., via machine screws, to an upper terminal end of the elongated and substantially planar connector bracket 205. The rotational coupling 206 rotatably attaches the joint assembly 214 to the upper frame section 10A of the exoskeleton system 10, e.g., such that the joint assembly 214 is swivelable about a vertical axis. Mounted to a lower terminal end of the connector bracket 205 is the hollowed socket outer shell 204 within which is housed the magnetic hip socket 207 and a proximal segment of the socket capsule 210. The sleeve-like socket capsule 210 is shown as a hollow and cylindrical one-piece structure that at least partially encases therein the cylindrical hip socket 207 and the ball portion of the ball shaft assembly 208, e.g., to help prevent dislocation of the joint assembly.

Magnetic ball shaft assembly 208 and socket capsule 210 are physically attached to the socket outer shell 204 by sliding the socket capsule 210 over the ball shaft assembly 208, inserting both the hip socket 207 and socket capsule 210 into a complementary central hole 217 inside the shell 204, and threading one or more machine screws in through complementary fastener slots in the side(s) of the shell 204. In so doing, the ball shaft 209 may pivot with respect to the shell 204 and bracket 205. The magnetic ball shaft assembly 208 attaches to the hip ball outer shell 211 by inserting the solid and cylindrical ball shaft 209 into a complementary central hole 219 inside the polyhedral outer shell 211, and threading one or more machine screws in through complementary fastener slots in the side(s) of the outer shell 211. In so doing, the magnetic hip socket 207 and, thus, the shell 204 and bracket 205 may pivot with respect to the plates 212, 213 and adaptor 225. In accord with the illustrated example, the magnetic hip socket 207 is cylindrical with a terminal end having a recessed spherical-cap-shaped socket cavity. In this instance, the magnetic ball 215 is spherical and nested in the socket cavity, whereas the magnetic ball shaft 209 is cylindrical and welded or otherwise rigidly secure to a side of the magnetic ball 215 opposite that of the hip socket 207. For simplicity of design and ease of assembly, it may be desirable that the magnetic socket 207 be fabricated as a discrete one-piece structure, and the magnetic ball 215 and the ball shaft 209 be fabricated as another discrete one-piece structure.

The hip ball outer shell 211 slides into a complementary central channel that is defined between parallel walls 221 and 223 of the motor adaptor 225; the outer shell 211 fastens to the adapter walls 221, 223, e.g., via machine screws or other suitable means. The bracket attachment plate 212 is shown mounted onto an upward facing recessed landing of the ligament alignment plate 213; both plates 212, 213 are then rigidly secured to an underside surface of the hip ball outer shell 211. The motor adaptor 225 and attachment plate 212 are structurally reinforced by the hip ball outer shell 211 and ligament alignment plate 213. The bracket attachment plate 212 mounts the articulating joint assembly 214 to an upper end of a thigh assembly 26 via a bracket plate (FIGS. 1 and 2). The articulating joint assembly 214 of FIGS. 3 and 4 may help to increase the hip range of motion of an exoskeleton frame 10. Reference herein to a “machine screw” may be interpreted to reference any suitable threaded fastener, rivets, anchors, pins, etc. Where appropriate, two or more mating components may be joined by welding, adhesives, joints, etc., as optional alternatives to using machine screws.

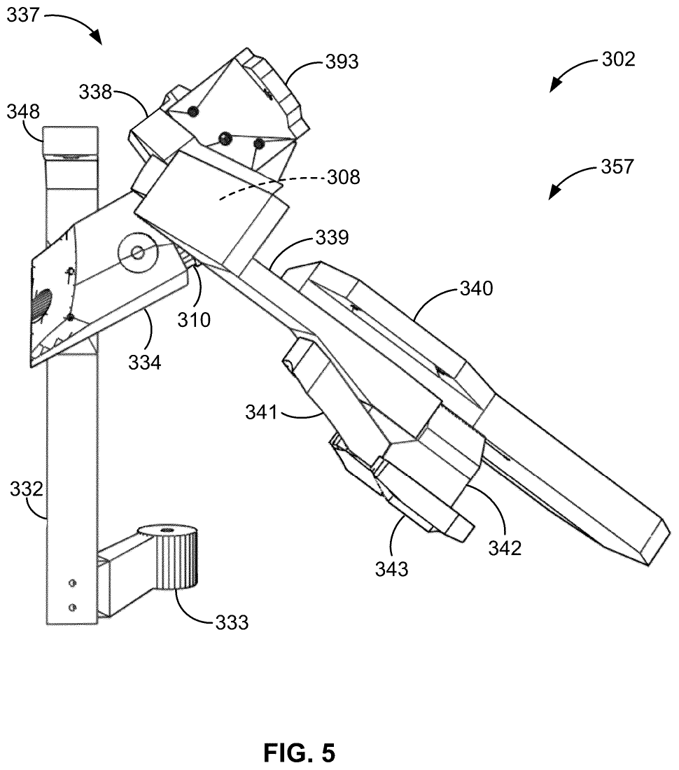

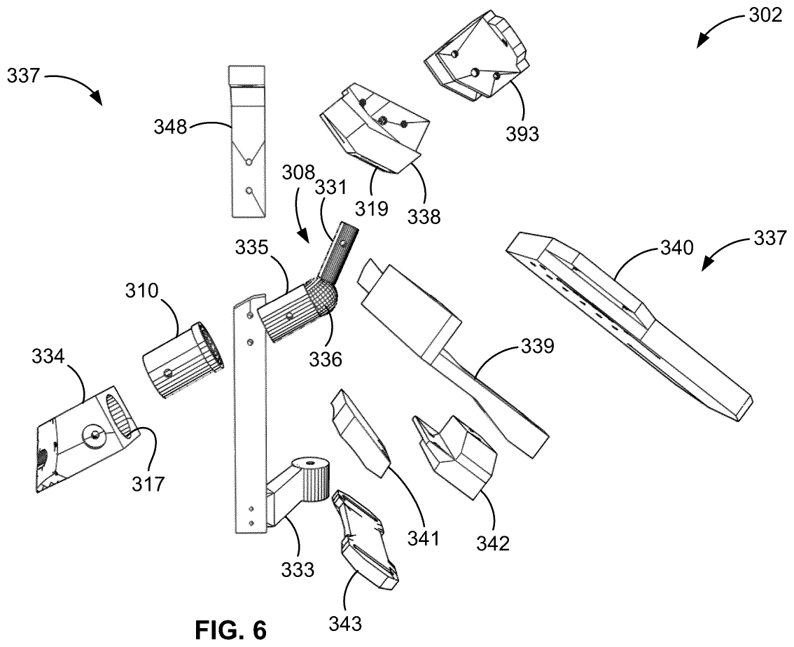

Presented in FIG. 5 is an isolated view of a representative joint & appendage (J&A) assembly 302, typified by a joint assembly 337 segment and an appendage assembly 357 segment that may be adapted for use as the shoulder assembly 37 and upper arm assembly 57 of FIGS. 1 and 2 (e.g., wherein a left joint assembly may be a mirror image of a right joint assembly). In accord with the illustrated example, the J&A assembly 302 of FIGS. 5 and 6 (also referred to herein as “passive exoskeleton shoulder and arm assembly”) may include at least the following components: a B&S ball shaft assembly 308, a rigid B&S socket capsule 310, a B&S magnetic shoulder ball shaft 331, a rigid connector bracket rail 332, a swivel-type rotational coupling 333, a rigid socket outer shell 334, a B&S magnetic shoulder socket 335, a B&S magnetic shoulder ball 336, a shoulder ball outer shell 338, a connector bracket plate 339, a humorous outer shell 340 plate, a rigid shell cap 341, a first outer shell loop 342 segment, a second outer shell loop 343 segment, a shoulder fixture 348, and a motor adaptor 393 mounting bracket. Similar to the articulating joint assembly 214 of FIGS. 3 and 4, the magnetic components presented in FIGS. 5 and 6 may be fabricated from suitable magnetic materials, and the other structural components may be fabricated from rigid and lightweight materials. While described herein for use as a shoulder joint and upper arm appendage, it should be appreciated that the articulating J&A assembly 302 may be employed for other exoskeleton joint locations without departing from the intended scope of this disclosure. It should also be recognized that the illustrated J&A assemblies may include greater or fewer components than what is illustrated, and some of the illustrated components may be modified, combined, or eliminated.

To assemble the J&A assembly 302 of FIGS. 5 and 6, a posterior (back) side of the flanged shoulder fixture 348 may be rigidly secured to a proximal terminal end of the elongated and substantially planar connector bracket rail 332, e.g., via machine screws. Rigidly secured, e.g., via machine screws, to a distal terminal end of the connector bracket rail 332, opposite that of the shoulder fixture 348, is the cylindrical and hollow rotational coupling 333. The rotational coupling 333 rotatably attaches the J&A assembly 302 to the back plate assembly 38, e.g., such that the J&A assembly 214 is swivelable about a vertical axis. An anterior (front) side of the shoulder fixture 348 may be rigidly secured, e.g., via machine screws, to the hollowed socket outer shell 334, within which is housed the magnetic socket 335 (FIG. 6) and a proximal segment of the socket capsule 310. Similar to the socket capsule 210 of FIGS. 3 and 4, the socket capsule 310 of FIGS. 5 and 6 is shown as a hollow and cylindrical sleeve-like, one-piece structure that at least partially encases therein the cylindrical socket 335 and the ball 336 portion of the ball shaft assembly 308, e.g., to help prevent dislocation of the joint.

To enable articulation of the joint assembly 337 portion of the J&A assembly 302, the socket 335 portion of the magnetic ball-and-socket assembly is inserted into the shoulder socket capsule 310; the mated magnetic shoulder socket 335 and capsule 310 are then partially inserted into a complementary central hole (“internal socket hole”) 317 of the shoulder socket shell 334. The socket 335 and capsule 310 are housed inside and rigidly attached to the shell 334, e.g., via machine screws. In so doing, the ball shaft 331 and any structure mounted thereto may pivot with respect to the shell 334, fixture 348, and coupling 333. The shaft 331 end of the magnetic ball shaft assembly 308 is inserted into a complementary central hole (“internal shaft hole”) 319 of the shoulder ball outer shell 338; the shaft 331 is rigidly attached to the outer shell 338, e.g., via machine screws. In so doing, the shoulder socket 335 and any structure mounted thereto may pivot with respect to the motor adaptor 393, outer shell 340 and shoulder shell loop 342, 343 segments.

The motor adaptor 393 is mounted onto an outboard side of the shoulder ball outer shell 338, e.g., via machine screws, whereas an inboard side of the shoulder ball outer shell 338 receives the ball shaft 331. The humerus connecting bracket 339 of the upper arm assembly 357 securely attaches, e.g., via machine screws, to the inboard side of the shoulder ball outer shell 338 adjacent the ball shaft 331. The plate-like outer shell 340 securely attaches to the outboard face of the humerus shoulder connecting bracket 339 via attachment of the deltoid outer shell cap 341 and the first deltoid outer shell loop 342 to the outer shell 340, e.g., via machine screws. The second deltoid outer shell loop 343 segment is then attached to the bottom of the first shell loop 342 using, for example, high-strength polymer-to-polymer adhesive. The J&A assembly 302 enables an exoskeleton frame structure to have increased range of motion of the shoulders while ensuring joint strength and improved life cycle.

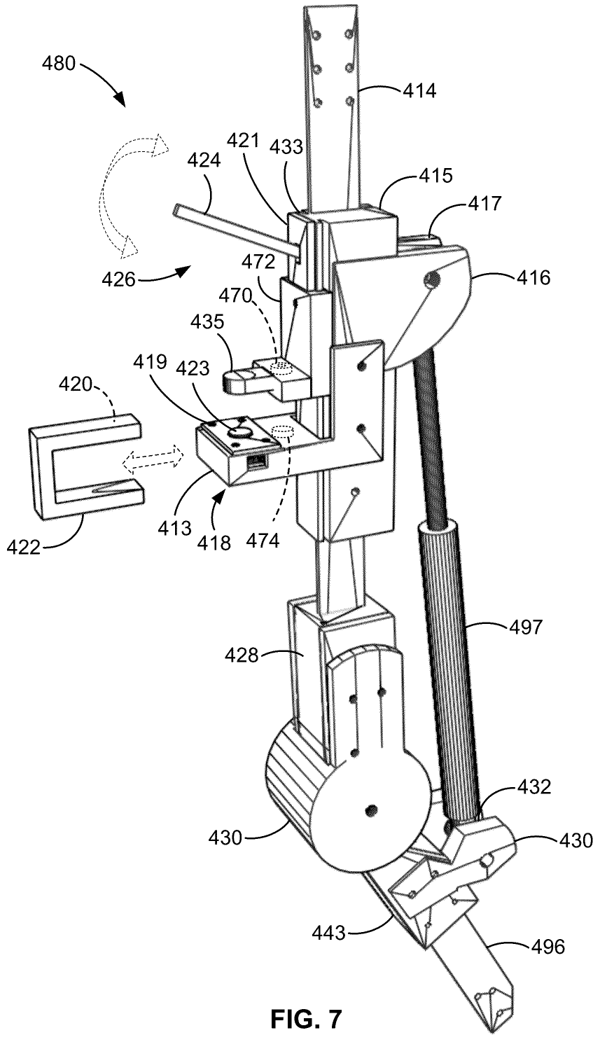

Turning next to FIG. 7, there is shown another example of an articulating joint and appendage (J&A) assembly 480, which includes an appendage assembly 426 segment and a joint assembly 430 segment that may be adapted for use as the thigh assembly 26, knee motor adaptor 27, and joint assembly 430 of FIGS. 1 and 2 (e.g., wherein left J&A units may be mirror images of right J&A units). The articulating J&A assembly 480 of FIGS. 7-9 (also referred to herein as “passive knee and thigh unit”) is shown in a locked state in which flexion and extension of the joint assembly 430 in the sagittal plane is substantially or completely prevented. J&A assembly 480 may generally comprise the appendage assembly 426 and appendage bracket 414, which are located at an upper end of the assembly 480, and the joint assembly 430 with an upper bracket 496, which are located at a lower end of the assembly 480. In this view, the appendage (thigh) bracket 414 inserts into a top end of an upper (femoral) knee joint connector 428 and thereby structurally connects the appendage (thigh) assembly 426 to the joint (knee) assembly 430. With this arrangement, the appendage bracket 414 may be an elongated metal mounting rail that is located adjacent to and extends the length of a user's femur, whereas the joint assembly 430 may be a spring-biased knuckle joint that is located adjacent to and articulates in unison with a user's knee joint.

The appendage assembly 426 portion of the J&A assembly 480 includes a torsional appendage (thigh) attachment bracket 415 that is vertically spaced from the joint assembly 430 and mounted (e.g., via press fit) onto a midsection of the appendage bracket 414. Two (outer and inner) upper spring mount attachment plates 416 and 417 are mounted onto opposing (medial and lateral) sides of and project rearward from the thigh attachment bracket 415. Both spring mount attachment plates 416, 417 are partially sandwiched between a magnetic locking device 418 and are rigidly secured in place, e.g., via machine screws. An upper end of a fluid-filled (hydraulic or pneumatic) spring device 497, which may be in the nature of a wrist pin receiver of a piston rod, is fixed, e.g., via a machine screw, to the laterally spaced spring mount attachment plates 416, 417. A lower region of the spring device 497, which may be in the nature of an end fitting of a fluid cylinder, is fixed, e.g., via a machine screw, to laterally spaced (inner and outer) lower spring mount plates 430 and 432. The two lower spring mount attachment plates 430 and 432 are mounted onto opposing (medial and lateral) sides of and project rearward from a lower (tibial) knee joint connector 443 of the knee assembly 430.

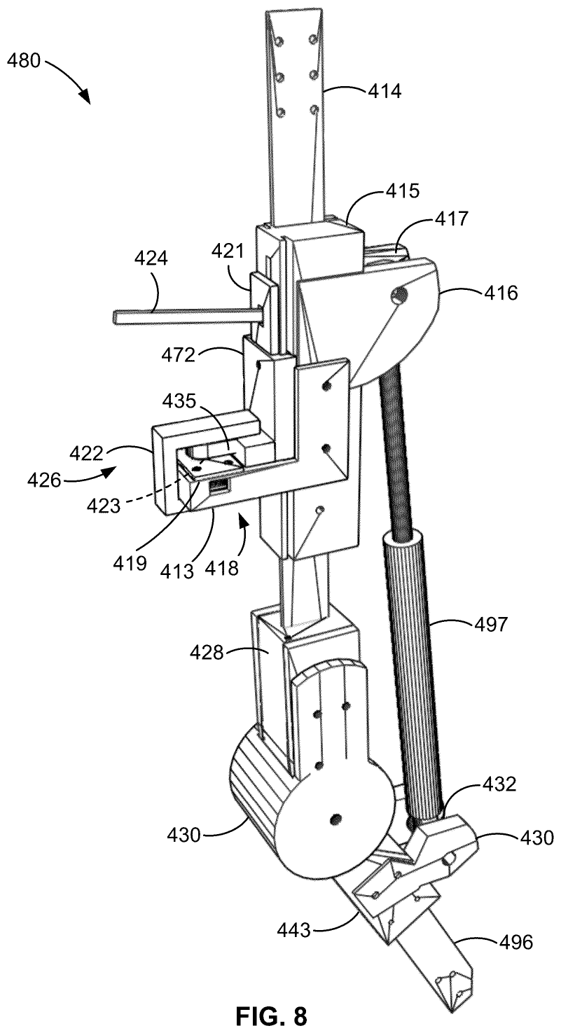

With continuing reference to FIG. 7, the magnetic locking device 418 contains a motor/clutch button switch 423 that is selectively actuable to govern operation of a corresponding motor unit (e.g., modular motor unit 103 of FIG. 2). The magnetic locking device 418 includes a protective locking mechanism housing 413 that houses the switch 423 components and rigidly affixes to the thigh attachment bracket 415, e.g., via machine screws. A sliding lock plate 472 of the locking device 418 is movably mounted onto a complementary slide track 433 of the thigh attachment bracket 415, e.g., to translate rectilinearly (up and down) in FIGS. 7 and 8 relative to the appendage bracket 414. At the same time, the sliding lock plate 472 is fixedly attached, e.g., via a machine screw, to a magnetic locking plate 421 such that the sliding lock plate 472, magnetic locking plate 421, and spring locking lever 424 translate in unison with one another. The spring locking lever 424 projects through complementary slots in the magnetic locking plate 421 and thigh attachment bracket 415 in order to mechanically couple to a top end of the spring device 497. With this arrangement, a user pivots the lever 424, e.g., in counterclockwise and clockwise directions in FIG. 7, to freely slide the locking plate 421 and, thus, the sliding lock plate 472 towards and away from the motor/clutch button switch 423 of the magnetic locking device 418. When the plate 472 is slid in a first directions (e.g., downwards in FIG. 7) into abutting engagement with the housing 413, a plate-borne magnet 470 embedded in a flange projecting from the slide lock plate 472 magnetically couples to a housing-borne magnet 474 embedded in the locking mechanism housing 413. The magnetically coupled magnets 470, 474 magnetically secure the locking device 418 in an unlocked state, as best seen in FIG. 8.

FIG. 8 portrays the articulating J&A assembly 480 of FIG. 7 in an unlocked state that enables substantially or wholly unencumbered flexion and extension of the joint (knee) assembly 430. To unlock the spring device 497, a user pulls or presses down on the spring locking lever 424 to thereby slide the slide lock plate 472 and magnetic locking plate 421 against a button switch plate 419 and the motor/clutch button switch 423. A C-shaped locking clip 422 is press fit onto a bottom surface of the housing 413 and a top surface of a T-shaped button cover flange 435 projecting orthogonally from the slide lock plate 472 to thereby lock the flange 435 onto the button switch 423 and retain the J&A assembly 480 in the unlocked state. With this arrangement, the button cover flange 435 extends across and conceals the button switch 423. One or more magnets 420 embedded within the C-shaped locking clip 422 help to retain the clip 422 on the flange 435 and housing 413. To lock the articulating J&A assembly 480, the C-shaped locking clip 422 is removed from the housing 413 and cover flange 435; once removed, the user rotates the spring locking lever 424 (e.g., clockwise in FIG. 8) to move the slide lock plate 472 upwards and away from the magnetic locking device 418, as best seen in FIG. 7.

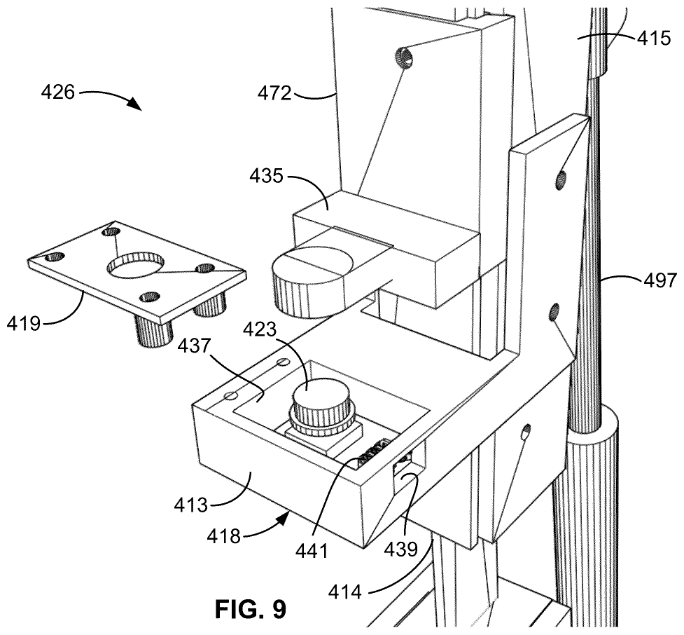

Presented in FIG. 9 is an enlarged and partially exploded perspective view of the motor/clutch button switch 423 of the magnetic locking device 418 of FIGS. 7 and 8 when the articulating J&A assembly 480 is in the locked state. In this Figure, the button switch plate 419 is lifted off of the locking mechanism housing 413 to show the motor/clutch button switch 423 nested within a complementary button cavity 437 inside the housing 413. A plug port 439 extending through a lateral wall of the locking mechanism housing 413 allows a user to mate a motor connector plug (not shown) with a complementary electrical terminal 441 that is located inside the button cavity 437 to thereby electrically connect a motor unit (e.g., motor unit module 102) to the motor/clutch button switch 423. The button switch plate 419 may be rigidly secured to the housing 413, e.g., via machine screws, to cover the button cavity 437 with the motor/clutch button switch 423 protruding through a complementary through-hole in the button switch plate 419.

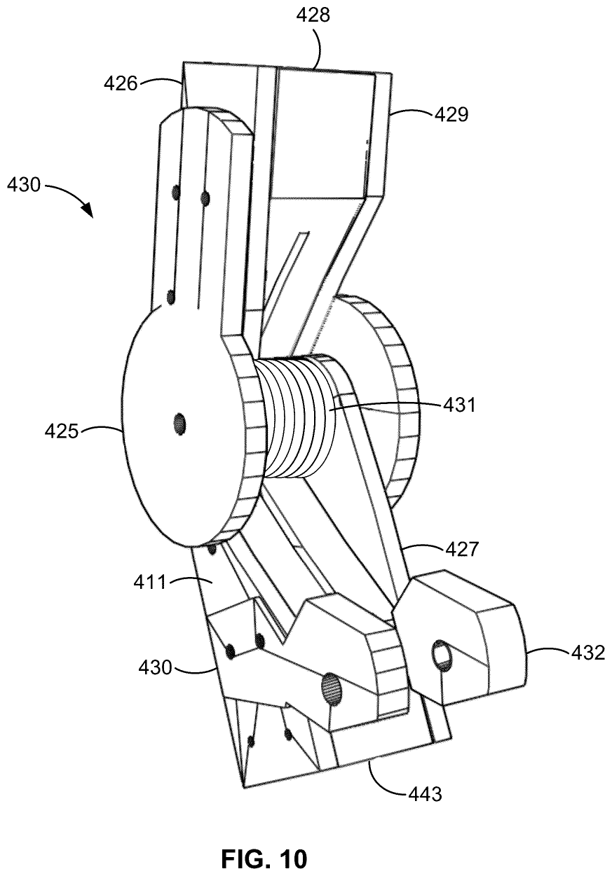

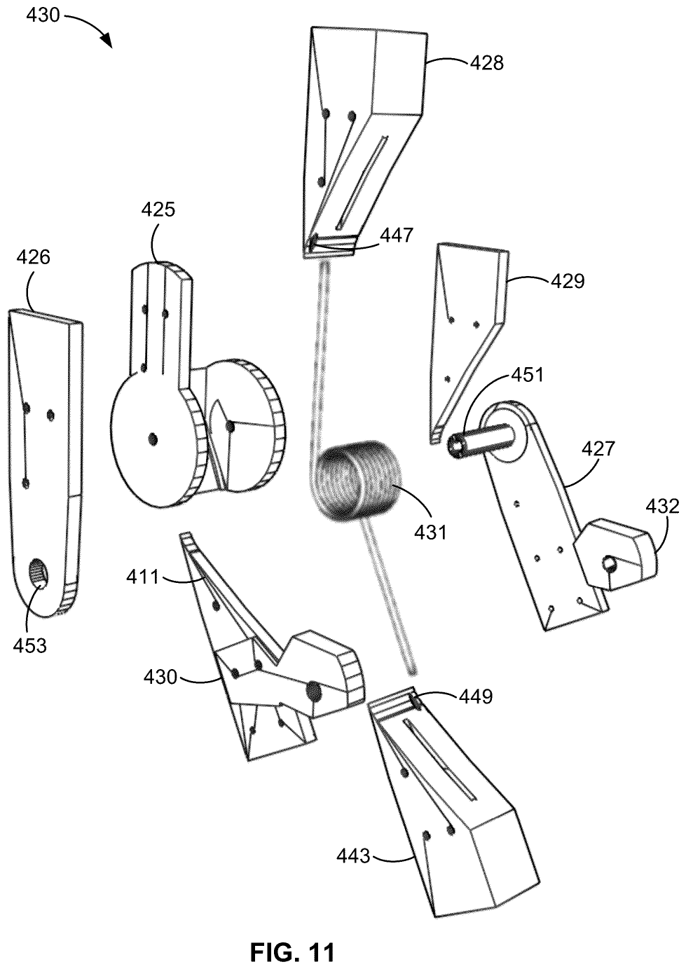

Turning next to FIG. 10, there is shown an enlarged, isolated view of the backside of the joint assembly 430 of FIGS. 7 and 8. In this view, a biasing member, such as helical torsion spring 431, is located inside a spring cavity defined between the upper and lower knee joint connectors 428, 443. Complementary slots 447 and 449 (FIG. 11) in the upper and lower knee joint connectors 428, 443, respectively, each receives one of the legs of the spring 431. This torsion spring 431 passively biases the joint assembly 430 towards an open (extension) state seen in FIG. 10. Mounted onto lateral flanks of the upper knee joint connector 428, e.g., via machine screws, are first and second upper torsion power plates 426 and 429. Mounted onto lateral flanks of the lower knee joint connector 443 are first and second lower torsion power plates 411 and 427, onto which are fixedly mounted the lower spring mount plates 430 and 432, respectively.

Defining a forward (patella) face and two lateral (ACL/MCL) faces of the knee joint assembly 430 is a mediolateral kneecap cuff 425 within which are sandwiched the upper and lower knee joint connectors 428, 443, the upper and lower torsion power plates 426, 429, 411, 427, and the torsion spring 431. To assemble the joint assembly 430, the upper power plates 426, 429 are fastened to the upper knee joint connector 428, and the lower power plates 411, 427 are fastened to the lower knee joint connector 443. A male pivot shaft 451 integral with and projecting orthogonally from an upper terminal end of the second lower torsion power plate 427 passes axially through the spring 431 and press-fits into a female pin slot 453 that extends through a lower terminal end of the first upper torsion power plate 426. The mediolateral kneecap cuff 425 is then pressed onto outer surfaces of the torsion power plates 426 and 427 and secured thereto, e.g., via multiple machine screws. An optional bottom bracket, cotter pin, clevis pin, or similarly suitable connector (not shown) may then be passed through holes in the kneecap cuff 425 that axially align with a hollow central core of the male pivot shaft 451. FIG. 11 presents an exploded view of the joint assembly 430 structure in FIG. 10 to better show the individual structural geometries of the knee assembly components described above.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the disclosure expressly includes any and all combinations and subcombinations of the preceding elements and features.

What is claimed:

1. A joint assembly for an exoskeleton system having an exoskeleton frame with first and second frame segments, the joint assembly comprising:
a socket outer shell configured to attach to the first frame segment and defining an internal socket hole;
a ball outer shell configured to attach to the second frame segment and defining an internal shaft hole; and
a ball-and-socket assembly including a magnetic socket defining a socket cavity, a magnetic ball movably nested in the socket cavity and magnetically mated with the magnetic socket, and a ball shaft rigidly attached to and projecting from the magnetic ball, the magnetic socket located inside the internal socket hole and rigidly attached to the socket outer shell, and the ball shaft located inside the internal shaft hole and rigidly attached to the ball outer shell.

2. The joint assembly of claim 1, further comprising a socket capsule located inside the internal socket hole of the socket outer shell and surrounding the magnetic socket.

3. The joint assembly of claim 2, wherein the socket capsule is rigidly attached to the socket outer shell and interposed between the magnetic socket and the socket outer shell.

4. The joint assembly of claim 3, wherein the socket capsule is a hollow and cylindrical one-piece structure.

5. The joint assembly of claim 1, wherein the magnetic socket is cylindrical, the magnetic ball is spherical, and the ball shaft is cylindrical.

6. The joint assembly of claim 5, wherein the magnetic socket is a first one-piece structure, and the magnetic ball and the ball shaft are a second one-piece structure.

7. The joint assembly of claim 1, wherein the socket outer shell is a hollow and truncated polyhedral one-piece structure.

8. The joint assembly of claim 1, wherein the ball outer shell is a hollow and polyhedral one-piece structure.

9. The joint assembly of claim 1, further comprising a connector bracket plate rigidly attached to the ball outer shell and configured to rigidly attach to the second frame segment to thereby attach the ball outer shell to the second frame segment.

10. The joint assembly of claim 1, further comprising a rotational coupling attached to the socket outer shell and configured to rotatably attach to the first frame segment to thereby attach the socket outer shell to the first frame segment.

11. The joint assembly of claim 10, further comprising a connector bracket extending between and rigidly attaching the socket outer shell to the rotational coupling such that the ball outer shell and the ball shaft are pivotable with respect to the rotational coupling.

12. The joint assembly of claim 1, further comprising a motor adaptor mounting bracket rigidly attached to the ball outer shell and configured to mount thereon a motor unit.

13. The joint assembly of claim 1, wherein the first frame segment includes a waist assembly attachable to a waist of a user or a back plate assembly attachable to a back of the user, the second frame segment includes a thigh assembly attachable to a thigh of the user or an arm assembly attachable to an arm of the user, and the joint assembly is a hip joint assembly, movably attaching the thigh assembly to the waist assembly, or a shoulder joint assembly, movably attaching the arm assembly to the back plate assembly.

14. An exoskeleton system comprising:
an exoskeleton frame including a first frame segment configured to attach to a trunk of a user and a second frame segment configured to attach to an appendage of the user; and
an articulating joint assembly including:
a rotational coupling rotatably attached to the first frame segment;
a socket outer shell attached to the rotational coupling and defining an internal socket hole;
a connector bracket rigidly attached to the second frame segment;
a ball outer shell attached to the connector bracket and defining an internal shaft hole; and
a ball-and-socket assembly including a magnetic socket defining a socket cavity, a magnetic ball movably nested in the socket cavity and magnetically mated with the magnetic socket, and a ball shaft rigidly attached to and projecting from the magnetic ball, the magnetic socket located inside the internal socket hole and rigidly attached to the socket outer shell, and the ball shaft located inside the internal shaft hole and rigidly attached to the ball outer shell.

15. A method of assembling a joint assembly for an exoskeleton system having an exoskeleton frame with first and second frame segments, the method comprising:
attaching a socket outer shell to the first frame segment of the exoskeleton frame, the socket outer shell defining therein an internal socket hole;
attaching a ball outer shell to the second frame segment of the exoskeleton frame, the ball outer shell defining therein an internal shaft hole;
receiving a ball-and-socket assembly including a magnetic socket defining a socket cavity, a magnetic ball movably nested in the socket cavity and magnetically mated with the magnetic socket, and a ball shaft rigidly attached to and projecting from the magnetic ball;
inserting the magnetic socket into the internal socket hole;
attaching the magnetic socket to the socket outer shell;
inserting the ball shaft into the internal shaft hole; and
attaching the ball shaft to the ball outer shell.

16. The method of claim 15, further comprising inserting a socket capsule into the internal socket hole of the socket outer shell such that the socket capsule surrounds the magnetic socket.

17. The method of claim 15, wherein the magnetic socket is cylindrical, the magnetic ball is spherical, and the ball shaft is cylindrical, and wherein the magnetic socket is a first one-piece structure, and the magnetic ball and the ball shaft are a second one-piece structure.

18. The method of claim 15, wherein attaching the socket outer shell to the first frame segment includes rigidly attaching the socket outer shell to a rotational coupling and rotatably attaching the rotational coupling to the first frame segment.

19. The method of claim 15, wherein attaching the ball outer shell to the second frame segment includes rigidly attaching the ball outer shell to a connector bracket plate and rigidly attaching the connector bracket plate to the second frame segment.

20. The method of claim 15, further comprising:
rigidly attaching a motor adaptor mounting bracket to the ball outer shell; and
mounting a motor unit onto the motor adaptor mounting bracket.
